(19) United States
(12) Patent Application Publication
(10) Pub. No.: US 2003/0233969 A1
(43) Pub. Date: Dec. 25, 2003

(54) Particulate material dispenser

(76) Inventor: Donald James Stolz, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/454,641

(22) Filed: Jun. 5, 2003

Related U.S. Application Data
(60) Provisional application No. 60/390,433, filed on Jun. 24, 2002.

(51) Int. Cl. A01C 5/02

(52) U.S. Cl. 111/92; 172/378

(57) ABSTRACT

A dispenser for dispensing particulate matter includes a hollow elongate body having sidewalls extending between opposite first and second ends. First and second end seals seal the first and second ends respectively. The first end seal has an orifice through which the particular material, when stored in the body, is dispensed. A baffle is mounted within the first end, generally abutting against one side wall of the body. The baffle at least partially occludes the orifice and forms a pocket between the orifice and the baffle. A convoluted dispensing flow path is thereby formed for dispensing the particulate material from the body, around the baffle and out of the dispenser through the orifice.

### CROSS REFERENCE TO RELATED APPLICATION

This application claims priority from U.S. Provisional Patent Application No. 60/390,433 filed Jun. 24, 2002 entitled Particulate Material Dispenser.

### FIELD OF THE INVENTION

This invention relates to the field of lightweight particulate material dispensers, which may be removably mounted to the handle of a garden-cultivating implement, or similar tool, for the convenient application of particulate material such as fertilizer, sand or like material.

### BACKGROUND OF THE INVENTION

The growing of garden plants for either aesthetics or sustenance involves regular surface manipulation of the garden soil for air and water entrainment and weed control, as well as for topical application of fertilizers around the plant for its nourishment and healthy growth.

The surface manipulation of the garden soil is generally undertaken by hand utilizing an implement of choice, usually a hoe or multi-tined cultivator, which enables the gardener to get in and around the plants without having to walk in the general vicinity of the plants and undesirably compact the soil. The application of fertilizer on the other hand may either be achieved by hand or by using a broadcast spreader or a scoop. A broadcast spreader is generally unsatisfactory since there is generally poor directional control of fertilizer within the garden environment so that much of the fertilizer is wasted by being accidentally misdirected onto pathways or outside the garden. Further, some of the fertilizer may be retained on the foliage or fruit of the plants where it can cause harm. Fertilizing by hand or by using a scoop requires one to walk within the garden thereby compacting the soil with the resultant need to re-cultivate the soil surface.

### SUMMARY OF THE INVENTION

The present invention therefore includes a light weight, generally tubular shaped dispenser which is mountable to the elongated handle of a garden cultivating implement such as a hoe or multi-tined cultivator in proximity to the head thereof. An end cap of the dispenser is provided with an orifice through which particulate material such as fertilizer, sand or the like may be accurately dispensed without the user having to walk in proximity to the plants.

The dispenser may have an arcuate shaped internal baffle positioned near the dispensing orifice so as to selectively restrict the discharge of particulate material. The baffle is mounted such that the dispenser must be inverted about its longitudinal axis and mildly agitated or shaken in general longitudinal axial alignment with the garden cultivating implement, so that particulate material can be dispensed.

In one embodiment of the invention an end plate, having a plurality of different diameter dispensing apertures or an elongate generally wedge-shaped or otherwise narrowing aperture formed therein, is rotatably mounted to an end cap of the dispenser such that a single aperture or portion of the elongate narrowing aperture, may be selectively aligned with the orifice in the end cap to control the amount of particulate material dispensed.

The body of the dispenser may be made of translucent or of transparent material so that the amount of material contained within the dispenser may be clearly evident.

The dispenser may be described as generally tubular, so that the dispenser has an elongated body. At opposite ends, first and second end caps may be either formed or mounted thereon. The first end cap may be removably fitted over a first end of the elongated body and is provided with an orifice towards a first side of the cap, through which particulate material such as fertilizer, sand or the like may be dispensed. The second end cap may be mounted to the second end of the elongated body. The dispensing orifice may be formed in generally tangential alignment with the inner surface of the elongated body of the tubular shaped dispenser. A dispensing tube may surround or be mounted as a spout in the orifice and extend cantilevered outwardly of first end cap.

The inner face of the first end cap, which is circular in cross section, is provided with a fixed arcuately shaped baffle, which extends generally at right angles to the longitudinal axis of the dispenser. A first end of the baffle is affixed by gluing or the like to a portion of the inner surface of first end cap so as to be in tangential alignment with the dispensing orifice. Opposed side edges of the baffle are also affixed to a portion of the inner surface of first end cap so as to compartmentalize an inner portion of the end cap. The second end of the baffle, opposite to the first end of the baffle is spaced, so as to provide a pocket, from the adjacent inside surface of first end cap. The baffle may be shaped as a funnel section, that is, as a sector of a conical frustum or cone so as to allow the channelled passage of particulate material from storage in the body of the dispenser to the dispensing orifice in the first end cap.

In an alternative embodiment, the first end cap may be provided with an externally mounted, rotatable end plate having a plurality of arcuately aligned dispensing orifices or apertures of different diameters formed therein and radially spaced therearound in radially spaced array about the axis of rotation of the plate. Dispensing tubes may be mounted to the apertures so as to extend outwardly as spouts from the end plate. Rotation of end plate selectively aligns a desired dispensing aperture in the end plate with the dispensing orifice in the first end cap.

The body of the dispenser is adapted so as to be removably mountable to the generally cylindrical pole-like handle of a garden-cultivating implement such as a hoe or tined cultivator. The garden implement may alternatively be a snow shovel when de-icing material and sand is required. These and other long-handled implements are collectively referred to herein as “implements”. To this end the body may have one or more spring clips fixed to it by riveting or the like. Alternatively, the body may have a longitudinal groove or channel formed along its length, which will snap or fit over, so as to accept into frictional engagement, a portion of the handle of the implement. The body of the dispenser may be manufactured from transparent material such as plastic or the like, so that the quantity of material stored or contained within the dispenser will be readily apparent to the user.

The dispenser is mounted to the implement with the first end cap positioned nearest to the head of the implement. The contents of the dispenser are prevented from accidental discharge from the dispensing orifice in first end cap by means of the internal baffle. Inverting the dispensing tube by simply rotating the implement and the attached dispensing tube one hundred eighty degrees about the longitudinal axis of the handle of the implement, followed by a mild shaking or agitation of both the implement and dispenser, metres a small portion of the stored particulate material, less than or equal to the volumetric capacity of the baffle pocket, from the pocket so as to be discharged from the dispensing nozzle.

In summary, the present invention may be characterized as a dispenser for dispensing particulate matter the dispenser including a hollow elongate body having sidewalls extending between opposite first and second ends. First and second end seals seal the first and second ends respectively. The first end seal has an orifice through which the particular material, when stored in the body, is dispensed. A baffle is mounted within the first end, generally abutting against one side wall of the body. The baffle at least partially occludes the orifice and forms a pocket between the orifice and the baffle. A convoluted dispensing flow path is thereby formed for dispensing the particulate material from the body, around the baffle and out of the dispenser through the orifice. The dispensing orifice may be adjacent the one side wall.

In one embodiment, the first end seal is a first end cap removably mounted onto the first end of the body by cap mounting means. Both seals may be end caps. The cap mounting means may be a snug sliding friction fit of the first end cap over the first end of the body. A spout may be mounted in the orifice so as to extend cantilevered outwardly of the orifice.

In an alternative embodiment, the first end seal further includes an apertured member rotatably mounted for rotation relative to the first end seal so that a user may selectively align an aperture on the apertured member with at least a portion of the orifice. The user may thereby selectively control the amount of occlusion of the orifice by the apertured member. The apertured member may be a rigid disc having at least one hole therethrough. Alternatively, the disc may have an array of radially spaced holes of different sizes. Further alternatively, the hole may be an elongate arcuate narrowing aperture.

A mounting means may be provided for mounting of the dispenser to an implement handle. The mounting means is mounted to a sidewall of the dispenser for releasably mounting the body to the handle of the implement. For example, the mounting means may include at least a pair of resilient clamping members mountable to the handle. Alternatively, the mounting means may include at least one concavity formed in the sidewalls of the dispenser for receiving the handle into resiliently clamped engagement within the concavity. The concavity may be an elongate channel.

The sidewall to which the mounting means is mounted may coincide with the one sidewall adjacent to which is the orifice and baffle. Alternatively they may be oppositely disposed so that the orifice and baffle are opposite to the mounting means.

The baffle may be a generally frusto-conically shaped section having a narrow end and an opposite wide end. The narrow end may be mounted to a sidewall and adjacent the first end seal. The wide end defines an oppositely disposed opening, opposite to the narrow end, into the pocket. The baffle thereby forms a funnel from the wide end to the orifice adjacent the narrow end. A rigid weir-like wall may be mounted across the wide end so as to partially block the opening into the pocket formed by the baffle.

### BRIEF DESCRIPTION OF THE DRAWINGS

FIG. 1, is a side perspective view of a garden cultivator implement with the dispenser of the present invention secured thereto with the cultivator in the cultivating mode.

FIG. 2 is a side perspective view of a garden cultivator implement with the dispenser of the present invention secured thereto with the dispenser in the dispensing mode.

FIG. 3 is a sectional view taken on line 3-3 of FIG. 1.

FIG. 3a is a sectional view similar to FIG. 3 of an alternative embodiment.

FIG. 3b is a further alternative embodiment of FIG. 3a.

FIG. 4 is a partially cut-away perspective view of the first end cap.

FIG. 4a is an alternative embodiment of the end cap of FIG. 4.

FIG. 5 is a sectional view taken on line 5-5 of FIG. 4.

FIG. 5a is a sectional view similar to FIG. 5 showing the dispensing tube in the non-rotated mode.

FIG. 5b is a sectional view along line 5b-5b of the alternative embodiment of FIG. 4a.

FIG. 6 is a perspective view of an alternative form of the first end cap.

FIG. 7 is a sectional view taken on line 7-7 of FIG. 6.

FIG. 8 is an exploded perspective view of an alternative embodiment of a particulate metering end cap according to the present invention.

FIG. 9 is an assembled perspective view of the end cap of FIG. 8.

FIG. 10 is a sectional view along line 10-10 in FIG. 9.

FIG. 11 is an exploded perspective view of an alternative embodiment of the dispenser according to the present invention.

FIG. 12 is an assembled perspective view of the dispenser of FIG. 11.

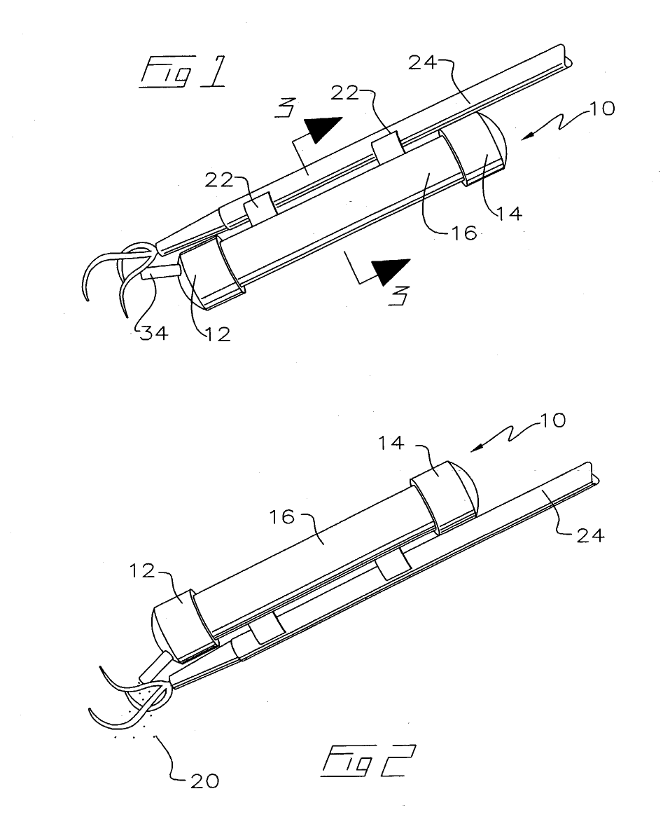

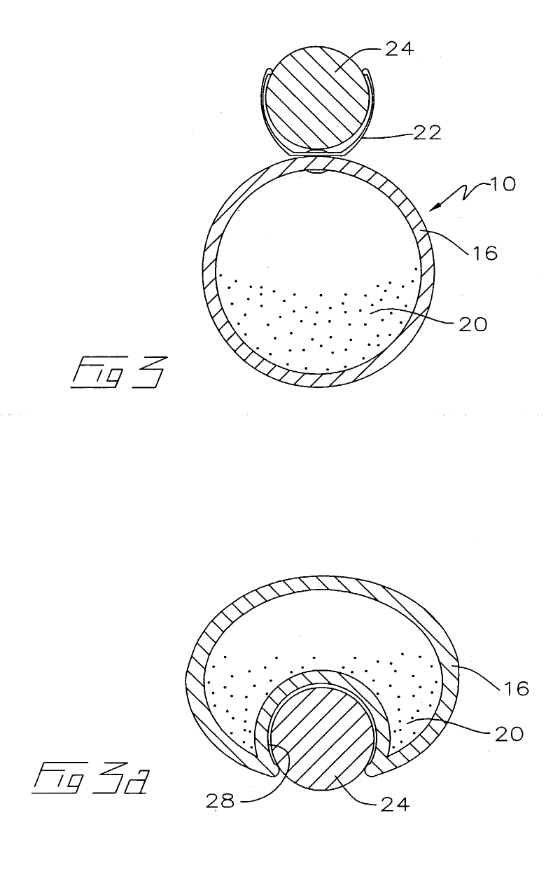

### DETAILED DESCRIPTION OF EMBODIMENTS OF THE INVENTION

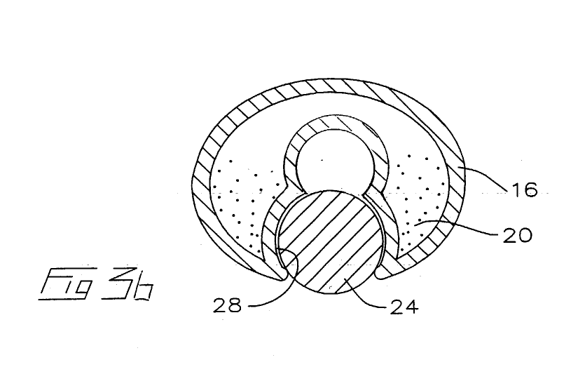

With reference to the drawing figures, wherein similar characters of reference denote corresponding parts in each view, the particulate material dispenser 10 is illustrated as having end caps 12 and 14 respectively, which close off the ends of a generally elongated hollow tubular body 16. In one embodiment, body 16 may be formed with sealed ends instead of using end caps to seal the ends of the tube. Dispenser 10 may be larger or smaller depending on the weight which may be conveniently carried by the user. Either end cap may be removable to allow the insertion into body 16 of particulate material 20, for example and without intending to be limiting, such as fertilizer, sand or other particulate material, in one use such as utilized within a flower or vegetable garden environment. End cap 14 may also be fixed or tubular body otherwise sealed at both ends, and body 16 provided with a side-filling closable aperture, door or other filling means. Tubular body 16 may be provided with external spring clips 22. Clips 22 frictionally engage an elongated handle 24, for example the handle of a garden implement such as a hoe, cultivator or rake or like tool. Alternatively, the elongated handle 24 of a garden implement may be releasably mounted to dispenser 10 by providing an elongated U shaped indentation, groove or channel 28 along one side of body 16. Channel 28 is shaped so as to resiliently clip or snap onto the handle. Channel 28 may be shaped to accommodate different thicknesses of handle, for example as seen in FIG. 3b. Dispenser 10 may be mounted on top of, or underneath the handle as convenient for the particular design. Of course, a small hand held dispenser 10 need not be handle-mounted at all.

First end cap 12 is provided with a dispensing orifice 30, through which particulate material 20 may flow to exit body 16. Orifice 30 is formed in end cap 12 so as to be in generally tangential alignment with the inner surface 32 of the tubular body 16 of dispenser 10. A dispensing spout or tube 34 may be mounted to, so as to surround, orifice 30 and extend cantilevered outwardly of first end cap 12.

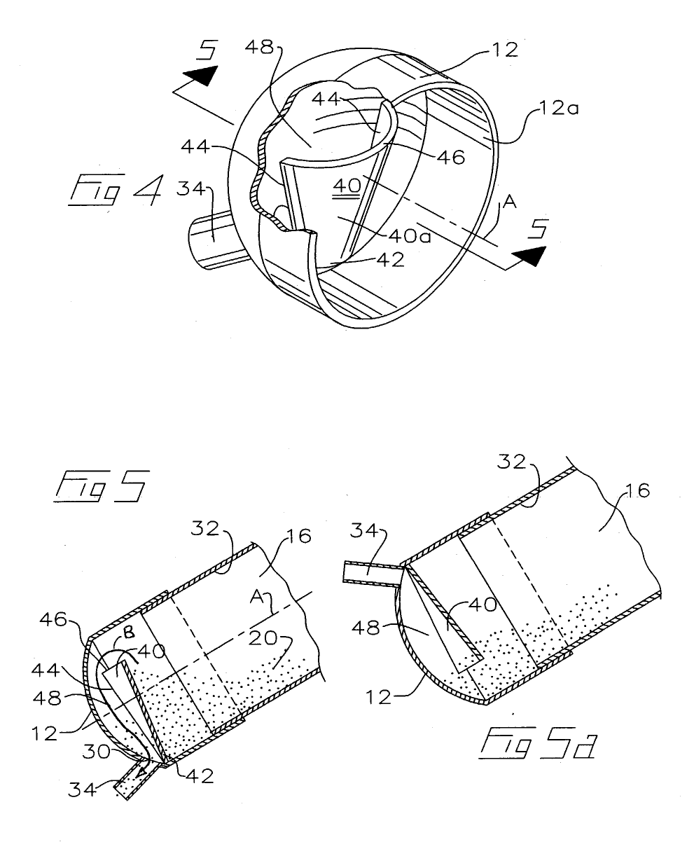

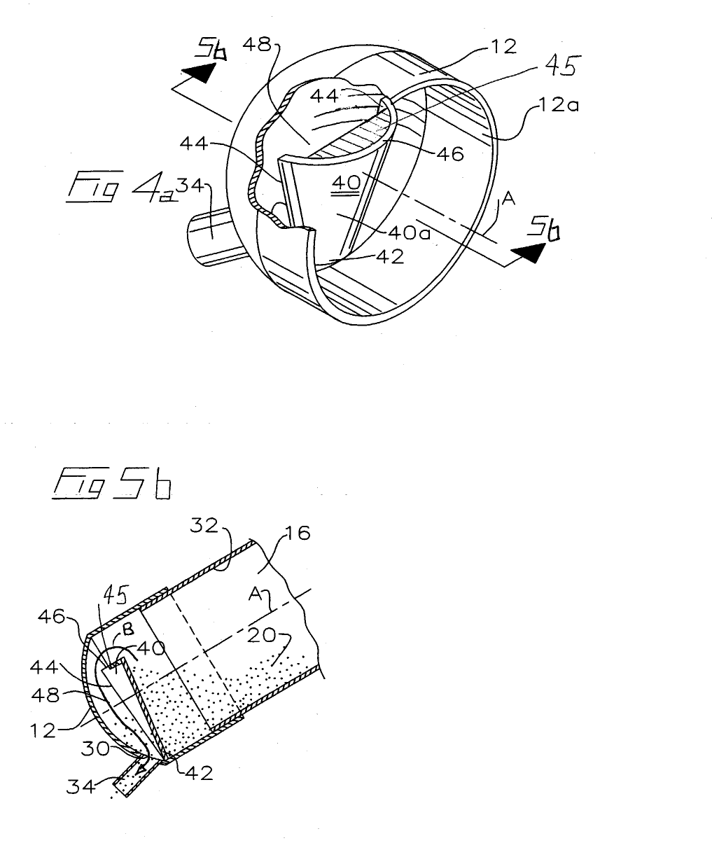

An arcuately shaped baffle 40, which extends generally at right angles to the longitudinal axis A of the dispenser 10, is fixedly positioned or otherwise mounted within end cap 12. The surface 40a of baffle 40 may be shaped as a conical sector or frusto-conical sector so as to extend inwardly of end cap 12. Baffle 40 has a first end 42 affixed to the inner surface 12a of end cap 12 in generally tangential alignment with orifice 30. Opposed side edges 44 of baffle 40 are also affixed to a portion of the inner surface 12a. Baffle 40 thus creates a pocket or compartment 48 within end cap 12 in communication with dispensing orifice 30 so that material in the pocket may be metered from the orifice in a controlled manner. That is, second end 46 of baffle 40, opposite to that of first end 42, is spaced apart from the adjacent inside surface 12a of cap 12 so as to provide a convoluted passage for the flow of particulate material in direction B from storage in dispenser 10 through compartment 48 to the dispensing orifice 30 in first end cap 12. In the alternative embodiment of FIGS. 4a and 5b, baffle 40 has a flow restricting wall 45 across the opening from body 16 into compartment 48 which partially occludes the opening.

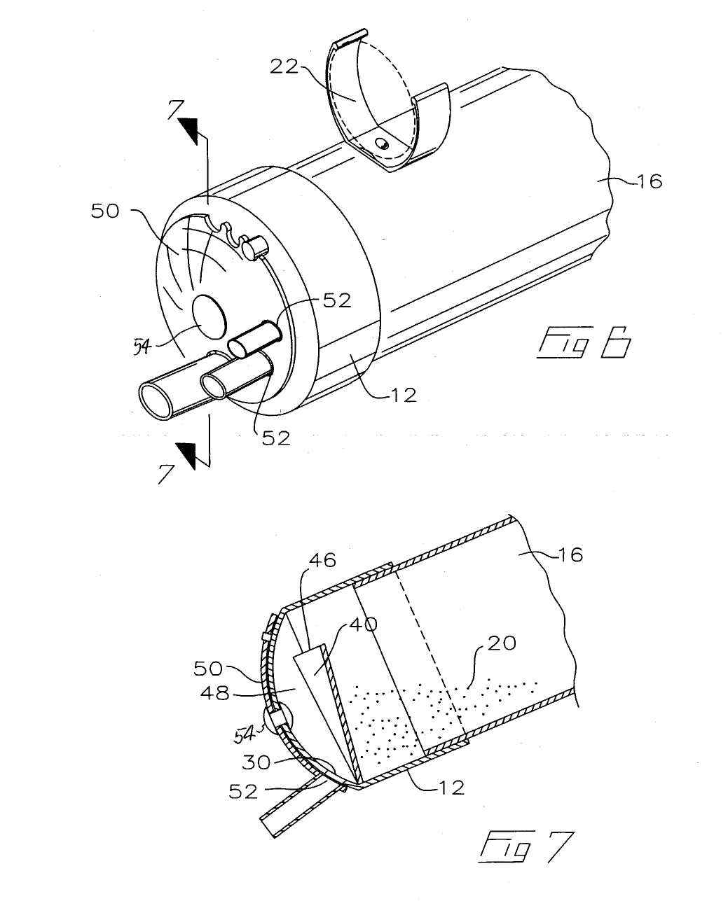

A further alternative embodiment of the present invention is illustrated in FIGS. 6 and 7, wherein a rotatable end plate 50 is rotatably mounted externally on first end cap 12 for rotation about axis A. End plate 50 is provided with a plurality of arcuately aligned dispensing orifices 52 of different diameters. As end plate 50 is rotated about pin 54 to selectively align a desired dispensing orifice 52 in the end plate 50 with dispensing orifice 30 in the first end cap 12, control over the amount of particulate material discharged from dispenser 10 is further controlled.

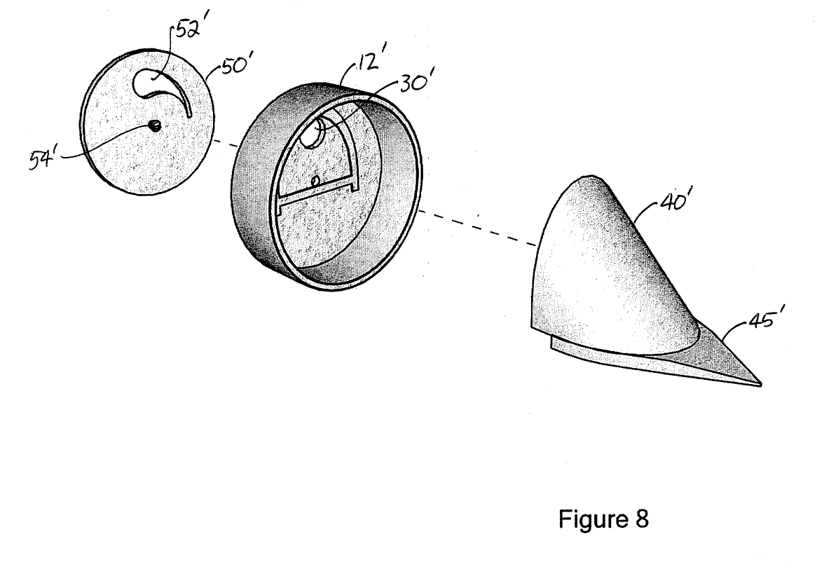

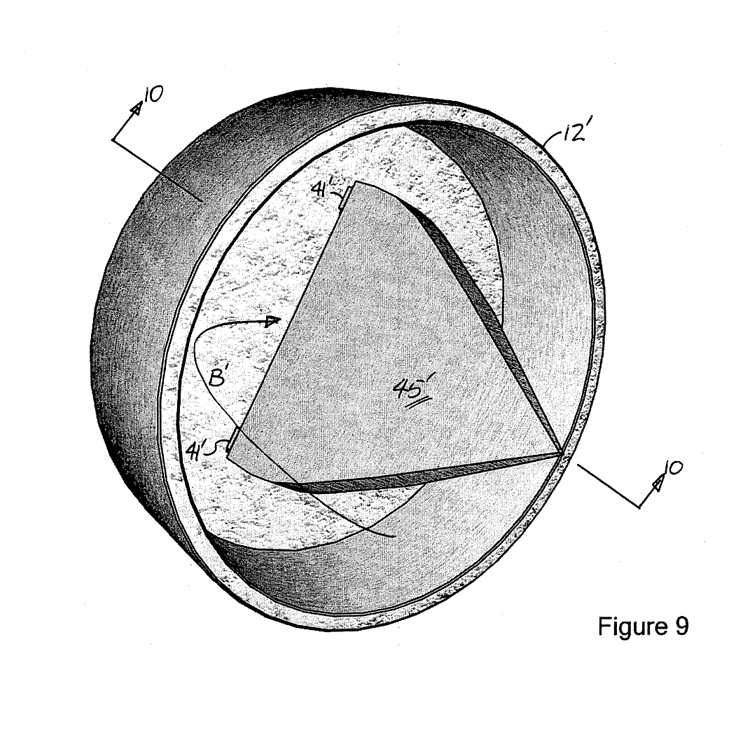

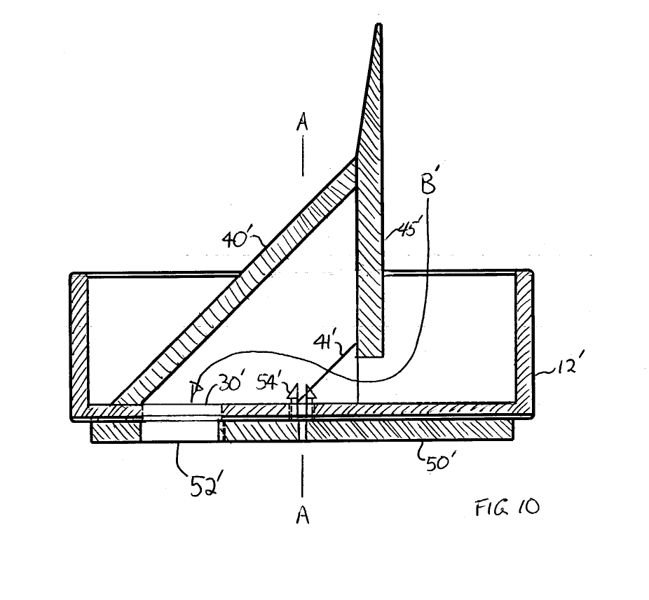

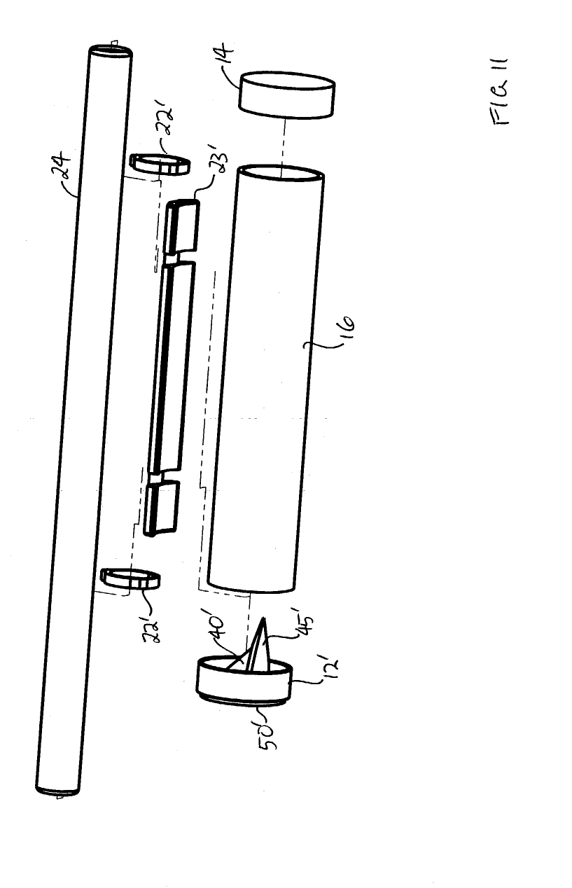

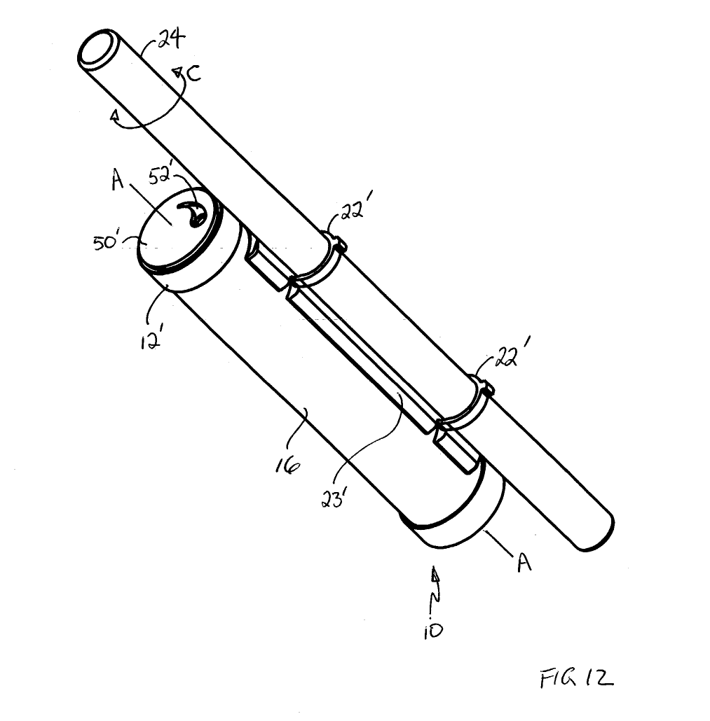

In a further alternative embodiment, as seen in FIGS. 8-12 rotatable end plate 50′ is rotatably mounted externally on end cap 12′ for rotation about axis A. End plate 50′ has an elongate narrowing aperture 52′ which may be described, without intending to be limiting, as an arcuately curved, wedge-shaped or spatulate-shaped aperture. Aperture 52′ is positioned on end plate 50′ so that a portion of aperture 52′ may be aligned to overlap dispensing orifice 30′ in end cap 12′ as end plate 50′ is rotated about axis A on pin 54′. Thus the size of the opening through which particulate matter may flow from the dispenser may be selectively adjusted between fully open and fully closed by rotation of plate 50′. A baffle, such as baffle 40′, and weir-wall 45′ mounted on feet 41′ within or adjacent end cap 12′ so as to block or dam particulate material in the dispenser cavity from flowing directly out of orifice 30′. Instead, particulate material must be manipulated so as to flow under the weir-wall and along a convoluted path B′ to reach orifice 30′ by the selective inversion of the dispenser about axis A for example by the rotation of handle 24 in direction C when the dispenser is mounted to the handle. The dispenser 10 may be mounted to the implement handle 24 for example by means of resilient clamping bands 22′ clamping base 23′ conformally against handle 24, base 23′ securely mounted to and along a sidewall of body 16.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A dispenser for dispensing particulate matter, said dispenser comprising a hollow elongate body having sidewalls extending between opposite first and second ends, first and second end seals sealing said first and second ends respectively, said first end seal having an orifice through which said particular material, when stored in said body, is dispensed, a baffle mounted within said first end, against one side wall of said sidewalls of said body, said baffle at least partially occluding said orifice and forming a pocket between said orifice and said baffle wherein a convoluted dispensing flow path is formed for dispensing said particulate material from said body, around said baffle and out of said dispenser through said orifice.

2. The dispenser of claim 1 wherein said first end seal is a first end cap removably mounted onto said first end of said body by cap mounting means.

3. The dispenser of claim 2 wherein said cap mounting means is a snug sliding friction fit of said first end cap over said first end of said body.

4. The dispenser of claim 1 wherein said dispensing orifice is adjacent said one side wall.

5. The dispenser of claim 4 further comprising a spout mounted in said orifice so as to extend cantilevered outwardly of said orifice.

6. The dispenser of claim 1 wherein said first end seal further comprises an apertured member rotatably mounted for rotation relative to said first end seal so that a user may selectively align an aperture on said apertured member with at least a portion of said orifice so as to selectively control the amount of occlusion of said orifice by said apertured member.

7. The dispenser of claim 6 wherein said apertured member is a rigid disc having at least one hole therethrough.

8. The dispenser of claim 7 wherein said at least one hole is an array of radially spaced holes of different sizes.

9. The dispenser of claim 8 wherein said at least one hole is an elongate arcuate narrowing aperture.

10. The dispenser of claim 4 wherein said first and second end seals are first and second end caps.

11. The dispenser of claim 4 wherein a mounting means is mounted to a sidewall of said sidewalls, said mounting means for releasably mounting said body to an elongate rigid handle of an implement.

12. The dispenser of claim 11 wherein said mounting means includes at least a pair of resilient clamping members mountable to the handle.

13. The dispenser of claim 11 wherein said mounting means includes at least one concavity formed in said sidewalls for receiving the handle into resiliently clamped engagement within said at least one concavity.

14. The dispenser of claim 13 wherein said at least one concavity is an elongate channel.

15. The dispenser of claim 11 wherein said sidewall is said one sidewall.

16. The dispenser of claim 11 wherein said sidewall is a sidewall opposite said one sidewall.

17. The dispenser of claim 1 wherein said baffle is a generally frusto-conically shaped section having a narrow end and an opposite wide end, wherein said narrow end is mounted to said one sidewall adjacent said first end seal, and said wide end defines oppositely disposed opening into said pocket, said baffle thereby forming a funnel from said wide end to said orifice adjacent said narrow end.

18. The dispenser of claim 17 further comprising a rigid wall across said wide end so as to partially block said opening.
